(19) United States
(12) Patent Application Publication
(10) Pub. No.: US 2013/0116974 A1
(43) Pub. Date: May 9, 2013

(54) METHODS AND SYSTEMS FOR TROUBLESHOOTING INSTALLATIONS OF DEVICES

(71) Applicants: John Christopher Boot, Sandy Springs, GA (US); Richard Dale Slates, Minden, NV (US)

(72) Inventors: John Christopher Boot, Sandy Springs, GA (US); Richard Dale Slates, Minden, NV (US)

(21) Appl. No.: 13/290,486

(22) Filed: Nov. 7, 2011

(51) Int. Cl. G06F 19/00; G06F 15/173

(52) U.S. Cl. 702/183; 709/224

(57) ABSTRACT

Methods and systems for use in troubleshooting installations of electronic devices are provided. In one example system for use in troubleshooting a plurality of intelligent electronic devices (IEDs), the system includes a computing device communicatively interfaced with a plurality of IEDs. The computing device includes a first communication interface to receive data from at least one IED and a processor coupled to the first communication interface. The processor is programmed to receive data from the at least one IED via the first communication interface and determine, based at least in part on the received data from the at least one IED, whether or not the plurality of IEDs is functioning properly.

### BACKGROUND OF THE INVENTION

The embodiments described herein relate generally to intelligent electronic devices and, more particularly, to methods and systems for troubleshooting installations of intelligent electronic devices.

Some commercial and/or industrial facilities include installations of intelligent electronic devices (IEDs). The IEDs include sensors, control systems, and other internet protocol devices that may be used to communicate information from one location to another. The installations of IEDs may be very large and complex and may include hundreds or thousands of IEDs, each of which may be generating significant quantities of data. With such large and/or complex installations, it may be difficult to identify whether or not the installation is functioning properly and whether or not any particular IED is functioning properly. Further, it may be difficult to detect counterfeit IEDs inserted within the installation. At least some known methods of troubleshooting installations of IEDs involve manually troubleshooting and checking each IED in an installation. Such manual troubleshooting may be time consuming and inefficient.

### BRIEF DESCRIPTION OF THE INVENTION

In one aspect, a system for use in troubleshooting a plurality of intelligent electronic devices (IEDs) is provided. The system includes a computing device communicatively interfaced with a plurality of IEDs. The computing device includes a first communication interface to receive data from at least one IED and a processor coupled to the first communication interface. The processor is programmed to receive data from the at least one IED via the first communication interface and determine, based at least in part on the received data from the at least one IED, whether or not the plurality of IEDs is functioning properly.

In another aspect, a method for use in troubleshooting a plurality of intelligent electronic devices (IEDs) is provided. The method includes receiving, by a computing device, data from at least one IED and determining, by the computing device, whether or not the plurality of IEDs is functioning properly based at least in part on the received data from the at least one IED.

In another aspect, an apparatus for use in troubleshooting a plurality of intelligent electronic devices (IEDs) is provided. The apparatus includes a memory device, a communications interface for coupling to the plurality of IEDs to intercept data transmissions from at least one IED of the plurality of IEDs, and a deep packet inspection module configured to extract data from the intercepted data transmissions and store the extracted data to said memory device

### BRIEF DESCRIPTION OF THE DRAWINGS

FIG. 1 is a block diagram of an exemplary system for use in troubleshooting a plurality of intelligent electronic devices.

FIG. 2 is a block diagram of another exemplary system for use in troubleshooting a plurality of intelligent electronic devices.

### DETAILED DESCRIPTION OF THE INVENTION

The following detailed description illustrates exemplary embodiments of the invention by way of example and not by way of limitation. It is contemplated that the invention has general application to analytical and methodical embodiments of managing operation and maintenance of widely geographically diverse power assets in industrial, commercial, and residential applications.

Exemplary embodiments of the methods and systems described herein relate to installations of intelligent electronic devices (IEDs). More particularly, the embodiments relate troubleshooting installations of IEDs.

The methods and systems described herein may be implemented using computer programming or engineering techniques including computer software, firmware, hardware or any combination or subset thereof, wherein an exemplary technical effect may include at least one of: (a) receiving data from at least one IED, and (b) determining whether or not an installation of IEDs is functioning properly based at least in part on received data from at least one IED.

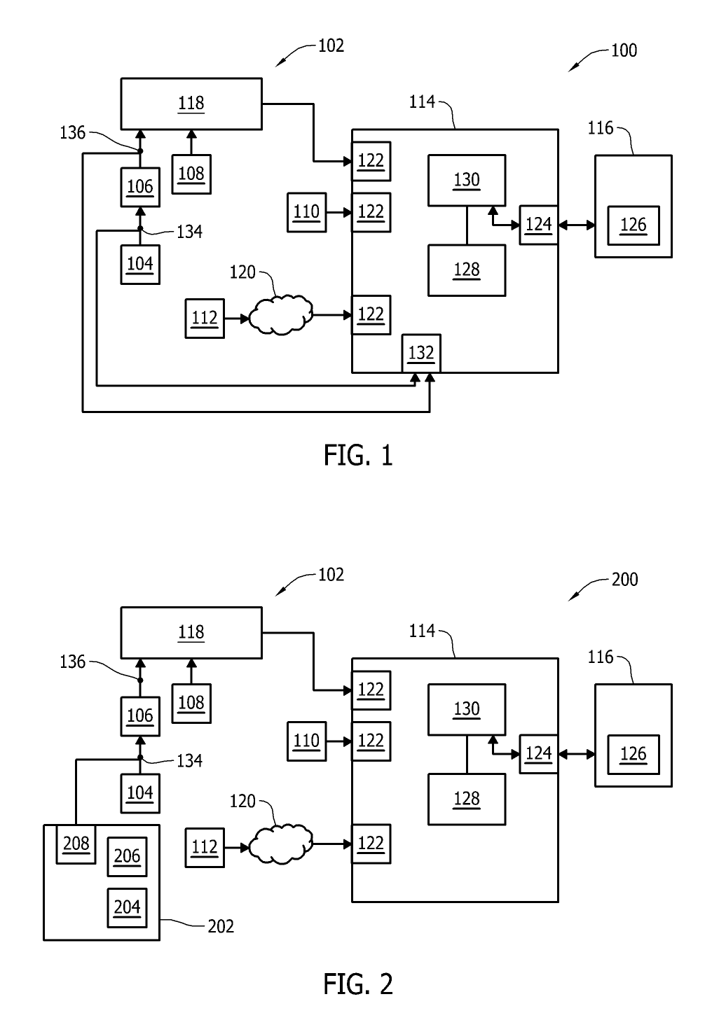

FIG. 1 is a block diagram of a system 100 for use in troubleshooting an installation 102 (also referred to herein as a plurality) of IEDs 104-112. In the exemplary embodiment, IEDs 104-112 are installed in a power distribution and/or transmission system. In other embodiments, IEDs 104-112 are installed in any other suitable commercial and/or industrial facility. System 100 includes a computing device 114 and a database 116. In the exemplary embodiment, database 116 is separate from computing device 114. In other embodiments, database 116 may be part of computing device 114. IEDs 104-108 are communicatively interfaced (e.g., coupled, connected, etc.) with computing device 114 via a router 118. IED 110 is coupled in communication with computing device 114 directly, while IED 112 is coupled in communication with computing device 114 via a wired or wireless network 120.

IEDs 104-112 may be any type of IED including, for example, sensors, control systems, and other devices communicating using internet protocol. Although five IEDs 104-112 are shown in FIG. 1, installation 102 may include more or fewer IEDs. Moreover, IEDs 104-112 may be communicatively coupled with computing device 114 by any suitable method of coupling for communication. For example, IEDs 104-108 are coupled to router 118, which is coupled in communication with computing device 114. The communicative connection between router 118 and computing device 114 may be a wired or wireless connection. Further, IED 104 is not directly coupled to router 118. Rather, IED 104 is coupled in communication with IED 106, which is coupled to router 118. IED 106 transmits or passes signals from IED 104 to computing device 114 through router 118. IEDs 110 and 112 are coupled to computing device without using router 118. IED 110 is directly coupled to computing device 114, while IED 112 is coupled to computing device 114 via network 120.

In the exemplary embodiment, computing device 114 includes three communications interfaces 122 to receive data from IEDs 104-112. In other embodiments, computing device 114 may include more or fewer communications interfaces 122. For example, in some embodiments, computing device may include a single communications interface 122 to which all IEDs 104-112 are communicatively coupled. Computing device 114 also includes a communications interface 124 to couple computing device 114 in communication with database 116.

Database 116 includes data 126 regarding IEDs 104-112. More specifically, in the exemplary embodiment, database 116 includes operational parameter data 126 for IEDs 104-112. The operational parameter stored as data 126 can include, for each IED 104-112, an expected frequency of data transmission, an expected range of values for transmitted data, an expected format for data transmission, and an expected protocol for data transmissions. In other embodiments, different and/or additional operational parameters may be included in data 126. In the exemplary embodiment, database 116 is separate from computing device 114. In other embodiments, database 116 may be included in computing device 114. Moreover, in some embodiments, database 116 may be remotely located from computing device.

Computing device 114 includes a memory device 128 and a processor 130 coupled to memory device 128 for executing instructions. In some embodiments, executable instructions are stored in memory device 128. Computing device 114 performs one or more operations described herein by programming processor 130. For example, processor 130 may be programmed by encoding an operation as one or more executable instructions and providing the executable instructions in memory device 128. Processor 130 may include one or more processing units (e.g., in a multi-core configuration). In some embodiments, computing device 114 and/or database 116 may be part of another controller (not shown), such as a system controller that controls operation of a system (not shown) in which installation 102 is located. In other embodiments, computing device 114 and/or database 116 may be separate from any other controller or may be partially separate from and partially part of another controller.

Memory device 128 is one or more devices that enable information such as executable instructions and/or other data to be stored and retrieved. Memory device 128 may include one or more computer readable media, such as, without limitation, dynamic random access memory (DRAM), static random access memory (SRAM), a solid state disk, and/or a hard disk. Memory device 128 may be configured to store, without limitation, computer-executable instructions, operational parameters for IEDs 104-112, data received from IEDs 104-112, and/or any other type of data.

In operation, computing device 114 receives data from IEDs 104-112. The data received from IEDs may vary among IEDs 104-112. For example one of IEDs 104-112 may be a sensor monitoring a voltage, one of IEDs 104-112 may be a sensor monitoring a temperature, one of IEDs 104-112 may be a control system controlling operation of a valve, etc. Each of IEDs 104-112 transmits appropriate data (e.g., a temperature measurement, a voltage measurement, a position of a valve, etc.) according to the type of IED that it is. Computing device 114 receives data from IEDs 104-112 via communication interfaces 122. Computing device 114 then determines, based at least in part on the received data, whether or not installation 102 is functioning properly. In some embodiments, determining whether or not installation 102 is functioning properly includes determining whether or not installation 102 includes one or more counterfeit or fake IEDs.

More specifically, in the exemplary embodiment, computing device 114 determines whether or not installation 102 is functioning properly based on whether or not the received data from each IED 104-112 conforms to operational parameter data 126 in database 116 for each IED 104-112. Computing device 114 may compare the content of received data to operational parameter data 126. For example, if the content of the received data from one of IEDs 104-112 includes a temperature, computing device 114 may compare the temperature to an expected range of temperatures, stored in operational parameter data 126, for the particular one of IEDs 104-112 from which the data was received. If the temperature is within the expected range, the temperature content does not indicate a malfunction in installation 102 with respect to the IED 104-112 from which the data was received. If instead the temperature falls outside the expected range, computing device 114 determines that installation 102 is not functioning properly. More particularly, computing device determines that the particular one of IEDs 104-112 from which the aberrant temperature data was received is not functioning properly. It should be noted that the range of expected values discussed herein does not necessarily correspond to a range of values indicating proper and/or improper operation of the system in which installation 102 is located. Moreover, in some embodiments, computing device 114 includes deep packet inspection instructions for retrieving the content of data transmissions.

Additionally, or alternatively, computing device 114 may compare characteristics of the received data to operational parameter data 126. The characteristics may include, but are not limited to, how often data is transmitted, a bit rate of a transmission, a format of a data transmission, a protocol of a data transmission, etc. For example, computing device 114 may compare how often data is received from a particular one of IEDs 104-112. This frequency is compared to an expected frequency, stored in operational parameter data 126, for the particular one of IEDs 104-112 from which the data was received. If the frequency is substantially the same as the expected frequency, a malfunction of installation 102 is not indicated by the frequency at which data was received from that one of IEDs 104-112. If instead the frequency differs from the expected frequency, computing device 114 determines that installation 102 is not functioning properly. More particularly, computing device determines that the particular one of IEDs 104-112 that is transmitting data at a different frequency than expected is not functioning properly.

In some embodiments, computing device 114 determines, based at least in part on the received data, whether or not one or more of IEDs 104-112 is a counterfeit or fake IED. Computing device 114 may determine whether or not the received data conforms to operational parameter data 126 and/or may compare characteristics of the received data to operational parameter data 126. If the received data for an IED does not conform to operational parameter data 126 or does not have the expected characteristics, computing device may identify the IED 104-112 from which the data was received as a potential counterfeit IED. Moreover, computing device 114 may compare received data from IEDs 104-112 to historical data for each IED 104-112. If the received data or its characteristics deviate from historical values and/or characteristics, the particular IED 104-112 from which the deviant data has been received may be identified as a counterfeit IED. Further, if data is received from a particular IED 104-112 for which computing device 114 has no records, the particular device transmitting the data may be identified as a counterfeit IED.

In the exemplary embodiment, computing device 114 is configured to intercept data transmissions from IEDs 104-112 at multiple points between each IED 104-112 and computing device 114. A data transmission intercepted at one point in installation 102 may be compared to the same data transmission intercepted at a different point in installation 102 to determine whether or not installation 102 is functioning properly. For example, in the exemplary embodiment, computing device 114 includes a communications interface 132 for receiving a data transmission at points 134 and 136 of installation 102. A data transmission from IED 104 may be intercepted at points 134 and 136 and compared. If the intercepted data transmission is not substantially the same at both points 134 and 136 (e.g., it has been corrupted), computing device 114 determines that installation 102 is not functioning properly. Moreover, computing device 114 may determine that installation 102 is not functioning properly somewhere between points 134 and 136. Although only two points 134 and 136 are shown in the FIG. 1, computing device 114 may be coupled to any number of locations within installation 102 to intercept data transmissions.

FIG. 2 is a block diagram of an exemplary system 200 for use in troubleshooting an installation 102 of IEDs 104-112. System 200 is similar to system 100 and the same reference numbers will be used to represent common components.

In the exemplary embodiment shown in FIG. 2, computing device 114 is not separately connected to points 134 and 136 to intercept data transmissions at points 134 and 136. Rather, system 200 includes an inspection module 202. Inspection module 202 is a computing device including a memory device 204 and a processor 206 coupled to memory device 204 for executing instructions. Inspection module 202 is coupled to points, such as point 134, of installation 102 via a communications interface 208 to intercept data transmissions from IEDs 104-112.

In some embodiments, executable instructions are stored in memory device 204. Inspection module 202 performs one or more operations described herein by programming processor 206. For example, processor 206 may be programmed by encoding an operation as one or more executable instructions and providing the executable instructions in memory device 204. Processor 206 may include one or more processing units (e.g., in a multi-core configuration).

Memory device 204 is one or more devices that enable information such as executable instructions and/or other data to be stored and retrieved. Memory device 204 may include one or more computer readable media, such as, without limitation, dynamic random access memory (DRAM), static random access memory (SRAM), a solid state disk, and/or a hard disk. Memory device 204 may be configured to store, without limitation, computer-executable instructions, deep packet instructions, intercepted data transmissions from IEDs 104-112, and/or any other type of data.

In the exemplary embodiment, inspection module 202 is configured to intercept data transmissions from IEDs 104-112. In FIG. 2, inspection module 202 is coupled, via communications interface 208 to point 134 to intercept data transmissions at point 134. In other embodiments, inspection module may be coupled to other points in installation 102 and/or may be coupled to more than one point in installation 102 at the same time. In the exemplary embodiment, processor 206 functions as a deep pocket inspection module and performs deep packet inspection on the intercepted data transmissions to extract desired information contained in the intercepted transmissions. In other embodiments, the deep packet inspection module may additionally or alternatively include deep packet inspection hardware (not shown). The data extracted from the intercepted data transmissions are stored to memory device 204. In other embodiments, the intercepted data transmissions may be stored to memory device 204 without deep packet inspection.

The intercepted data transmissions and/or content extracted from the data transmissions are used to troubleshoot installation 102. In the exemplary embodiment, inspection module 202 is configured to compare the intercepted data transmissions and/or content acquired at two different points, such as points 134 and 136. If the intercepted data transmission is not substantially the same at both points 134 and 136 (e.g., it has been corrupted), inspection module 202 determines that installation 102 is not functioning properly. Moreover, inspection module 202 may determine that installation 102 is not functioning properly somewhere between points 134 and 136. In other embodiments, inspection module 202 may store intercepted data transmissions and/or extracted content for analysis as described herein by another computing device, such as computing device 114. In some embodiments, inspection module 202 transmits intercepted data transmissions and/or extracted content, such as over a wired or wireless network 120, or via direct connection, to another device, such as computing device 114, for analysis as described herein. Further, in some embodiments, troubleshooting device 202 is configured to access database 116 via a wired or wireless communications network (not shown). In such embodiments, troubleshooting device 202 may analyze the intercepted data transmissions and/or extracted data to determine whether or not installation 102 is functioning properly based on operational parameter data 126 similar to computing device 114 in the embodiment shown in FIG. 1 and described above.

Inspection module 202 is, in the exemplary embodiment, a portable device, separable from and moveable within installation 102. Inspection module 202 may be coupled to point 134, for example to intercept data transmissions at point 134, and then detached and coupled to point 136 to intercept data transmissions at point 136. Thus, a single inspection module 202 may be used to collect data transmissions from various points throughout installation 102. In other embodiments, inspection module 202 may be fixedly coupled within installation 102. In such embodiments, multiple inspection modules 202 may be coupled to different points, e.g., points 134 and 136, in installation 102 to intercept data transmissions at the various points in installation 102. The intercepted data and/or extracted content may be transmitted to a remote computing device, such as computing device 114, for analysis as described herein.

The above-described embodiments of a method and system of troubleshooting installations of devices provide automated troubleshooting of installations of intelligent electronic devices. By comparing data transmissions from IEDs in the installation with expected operational parameters, the embodiments provide automatic determinations of improper operation of the installation. Moreover, the embodiments aid in locating where in the installation the improper operation of the installation is occurring. Further, various locations within the installation may be monitored to identify if and where a data transmission, which may otherwise be proper, is being corrupted. Thus, the embodiments described herein may facilitate troubleshooting complex installations of IEDs that would otherwise involve extensive manual troubleshooting. Significant time and costs may be saved through use of embodiments of this disclosure and operation of an installation of IEDs may be improved.

Exemplary embodiments of methods, systems, and apparatus are described and/or illustrated herein in detail. The methods, systems, and apparatus are not limited to the specific embodiments described herein, but rather, components of each system, as well as steps of each method, may be utilized independently and separately from other components and steps described herein. Each component, and each method step, can also be used in combination with other components and/or method steps.

Although specific features of various embodiments of the invention may be shown in some drawings and not in others, this is for convenience only. In accordance with the principles of the invention, any feature of a drawing may be referenced and/or claimed in combination with any feature of any other drawing.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present disclosure have been described in detail, it will be understood by those skilled in the art that various modifications can be made therein without departing from the spirit and scope of the disclosure as set forth in the appended claims.

A controller, computer, or computing device, such as those described herein, includes at least one processor or processing unit and a system memory. The controller typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Embodiments of the disclosure may be described in the general context of computer-executable instructions, such as program components or modules, executed by one or more computers or other devices. Aspects of the disclosure may be implemented with any number and organization of components or modules. For example, aspects of the disclosure are not limited to the specific computer-executable instructions or the specific components or modules illustrated in the figures and described herein. Alternative embodiments of the disclosure may include different computer-executable instructions or components having more or less functionality than illustrated and described herein.

When introducing elements/components/etc. of the methods, systems, and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for use in troubleshooting a plurality of intelligent electronic devices (IEDs), said system comprising:
a computing device communicatively interfaced with the plurality of IEDs, said computing device comprising:
a first communication interface to receive data from at least one IED; and
a processor coupled to said first communication interface, said processor programmed to:
receive data from the at least one IED via the first communication interface; and
determine, based at least in part on the received data from the at least one IED, whether or not the plurality of IEDs is functioning properly.

2. A system in accordance with claim 1, further comprising a database that includes operational parameter data for a plurality of IEDs in the plurality of IEDs, and wherein determining whether or not the plurality of IEDs is functioning properly is based at least in part on whether or not the data received from the at least one IED conforms with operational parameter data for the at least one IED stored in said database.

3. A system in accordance with claim 2, wherein determining whether or not the plurality of IEDs is functioning properly comprises determining if the IED from which the data was received is functioning according to the operational parameter data for that IED stored in said database.

4. A system in accordance with claim 3, wherein the operational parameter data for the at least one IED stored in said database includes at least one of a frequency of data transmission by the IED, a range of expected values for data from the IED, a format of data from the IED, and a data protocol for the TED.

5. A system in accordance with claim 2, wherein said processor is further configured to generate an indicator that the at least one IED is not functioning properly if the processor determines that operation of the IED does not conform with the operational parameter data for that TED.

6. A system in accordance with claim 2, wherein said computing device further comprises a second communication interface for receiving the operational parameter data from said database, and wherein said computing device is coupled to said database via said second communication interface.

7. A system in accordance with claim 1, wherein receiving data from the at least one IED comprises intercepting a data transmission from the at least one IED at a first location and a second location in the plurality of IEDs.

8. A system in accordance with claim 7, wherein determining whether or not the plurality of IEDs is functioning properly is based at least in part on a comparison of the data transmission intercepted at the first and second locations in the plurality of the IEDs.

9. A system in accordance with claim 8, wherein determining whether or not the plurality of IEDs is functioning properly comprises determining the plurality of IEDs is not functioning properly if the data transmission intercepted at the first location and the second location are not substantially the same.

10. A system in accordance with claim 1, wherein determining whether or not the plurality of IEDs is functioning properly comprises determining whether or not the at least one IED is a counterfeit TED.

11. A method for use in troubleshooting a plurality of intelligent electronic devices (IEDs), said method comprising:
receiving, by a computing device, data from at least one IED; and
determining, by the computing device, whether or not the plurality of IEDs is functioning properly based at least in part on the received data from the at least one IED.

12. A method in accordance with claim 11, wherein said determining whether or not the plurality of IEDs is functioning properly comprises determining whether or not the data received from the at least one IED conforms with operational parameter data for the at least one IED stored in a database.

13. A method in accordance with claim 11, wherein said determining whether or not the plurality of IEDs is functioning properly comprises determining whether or not the data received from the at least one IED conforms with operational parameter data including at least one of a frequency of data transmission by the IED, a range of expected values for data from the IED, a format of data from the IED, and a data protocol for the IED.

14. A method in accordance with claim 11, wherein said receiving data from the at least one IED comprises intercepting a data transmission from the at least one IED at a first location and a second location in the plurality of IEDs.

15. A method in accordance with claim 14, wherein said determining whether or not the plurality of IEDs is functioning properly comprises a comparison of the data transmission intercepted at the first and second locations in the plurality of the IEDs, and determining the plurality of IEDs is not functioning properly if the data transmission intercepted at the first location and the second location are not substantially the same.

16. A method in accordance with claim 11, wherein said determining whether or not the plurality of IEDs is functioning properly comprises determining whether or not the at least one IED is a counterfeit IED.

17. An apparatus for use in troubleshooting a plurality of intelligent electronic devices (IEDs), said apparatus comprising:
a memory device;
a communications interface for coupling to the plurality of IEDs to intercept data transmissions from at least one IED of the plurality of IEDs; and
a deep packet inspection module configured to extract data from the intercepted data transmissions and store the extracted data to said memory device.

18. An apparatus in accordance with claim 17, further comprising an analysis module, said analysis module comprising a processor programmed to:
determine, based at least in part on the extracted data from the intercepted data transmissions, whether or not the plurality of IEDs is functioning properly.

19. An apparatus in accordance with claim 18, wherein said analysis module processor is programmed to determine whether or not the plurality of IEDs is functioning properly by comparing the extracted data to operational parameters for the at least one IED.

20. An apparatus in accordance with claim 17, further comprising a communications interface for coupling to an analysis module comprising a processor programmed to determine whether or not the plurality of IEDs is functioning properly, based at least in part on the extracted data stored to said memory device.
